(19) United States
(12) Patent Application Publication
(10) Pub. No.: US 2024/0192167 A1
(43) Pub. Date: Jun. 13, 2024

(54) CAPILLARY ELECTROPHORESIS APPARATUS

(71) Applicant: Werner DÖBELIN, Reinach (CH)

(72) Inventor: Werner DÖBELIN, Reinach (CH)

(21) Appl. No.: 18/568,242

(22) PCT Filed: Jun. 8, 2022
(86) PCT No.: PCT/EP2022/065614

§ 371 Date: Dec. 7, 2023

(30) Foreign Application Priority Data
Jun. 8, 2021 (CH) 00675/21

(51) Int. Cl. G01N 27/447; B01D 19/00; B01D 71/36

(52) U.S. Cl. CPC G01N 27/44743; B01D 19/0031; B01D 71/36; G01N 27/44713; G01N 27/44791

(57) ABSTRACT

Capillary electrophoresis apparatus, comprising: (a) a supply capillary (4); (b) a degassing conduit (6); (c) a separation capillary (8); wherein the supply capillary (4), the degassing conduit (6), and separation capillary (8) each have an inlet and an outlet connected to the inlet via a channel, wherein in particular the respective channel is adapted to conduct a liquid from the corresponding inlet to the connected outlet; wherein the supply capillary (4), the degassing conduit (6), and the separation capillary (8) are connected to each other to form a continuous channel by means of which in particular liquid may be conducted from the inlet of the supply capillary (4) to the outlet of the separation capillary (8); an injection port (18) for feeding sample substance into the separation capillary (8); a pump (1), by means of which electrolyte solution may be conveyed from a reservoir (3) and pumped in the direction of and/or through the continuous channel; a first electrode (12) which extends within the degassing conduit (6), in particular within the channel of the degassing conduit (6).

This application claims the priority of Swiss patent application 00675/21 dated Jun. 8, 2021, the contents of which are hereby incorporated by reference in their entirety.

The invention relates to the field of analytics, in particular the analytics of biological samples. It relates to a capillary electrophoresis apparatus according to claim 1.

### TECHNOLOGICAL BACKGROUND

The term capillary electrophoresis refers to a family of separation techniques used in analytics, particularly medical and biological analytics, as described, for example, in the Wikipedia articles
https://en.wikipedia.org/w/index.php?title=Capillary_electrophoresis&oldid=1015696492 and
https://de.wikipedia.org/w/index.php?title=Kapillarelektrophorese&oldid=206569890
which are hereby incorporated by reference in their entirety.

In accordance with common usage, the term may also be understood below as a synonym for so-called capillary zone electrophoresis.

For more precise determination and/or identification of components of a sample separated by capillary electrophoresis, mass spectrometry may be performed downstream of capillary electrophoresis. For this purpose, an eluate provided by the capillary electrophoresis, in particular one emerging from a capillary electrophoresis apparatus, may be subjected to electrospray ionization, as described, for example, in Wikipedia article
https://en.wikipedia.org/w/index.php?title=Electrospray_ionization&oldid=1017401262
which is hereby incorporated by reference in its entirety.

The connection of capillary electrophoresis and mass spectrometry in series places high demands on the design of an interface between capillary electrophoresis and mass spectrometry, but also on the quality and stability of the capillary electrophoresis. A possible interface is described in U.S. Pat. No. 4,885,076, certain elements for such an interface in U.S. Pat. No. 5,993,633; both of which are hereby incorporated by reference in their entirety.

### BRIEF DESCRIPTION OF THE INVENTION

The invention relates, inter alia, to a method and an apparatus for pressure-driven capillary electrophoresis, in particular with a sample feeder system for coupling to a mass spectrometer for the analytics of biological samples, as is typically required in proteomics for the determination of proteins.

The invention further relates to a capillary electrophoresis (CE) system with a closable sample receiving part, in which the electroosmotic flow is supported by a pump, in particular additionally electrolyte solution resp. a buffer or a buffer solution (hereinafter simplified referred to as electrolyte solution) is conveyed through a CE capillary, so that the capillary electrophoresis takes place independently of a static pressure, the electrolyte solution is degassed in the area of an electrode at the inlet and a high-voltage (HV) electrode leads into the degassing channel, the CE capillary is supplied with the electrolyte solution through the degassing channel, the electrolyte solution is set to a mass spectrometry (MS) spray potential at the exit of the CE capillary by means of an output electrode, and the MS spray potential is protected from the CE high voltage by means of a voltage divider. The MS spray potential may be substantially lower than a high voltage potential at the high voltage (HV) electrode, in particular by a factor of 10 to 100; but may also be 0V in certain configurations, where the output electrode may be grounded in particular.

In analytics, great efforts have long been made to obtain the most accurate, sensitive, and reproducible results possible with the smallest possible sample volumes. Conventional procedures in CE-MS analytics show that CE has generally known advantages over HPLC in the area of separation performance and required sample volume. However, it has also been shown that the coupling of a CE system with an MS is very fragile. The influence of static pressure across the CE capillary, possible gas bubble formation at the HV electrode and/or in the CE capillary, sample introduction and maintaining the spray condition in the MS source, complicate or make impossible the robust operation of a CE-MS coupling. Gas bubble formation at the HV electrode and/or in the CE capillary may lead, at least temporarily, to an abortion or interruption of the electroosmotic flow, which may be caused in particular by the fact that the gas bubble represents at least approximately an electrical insulator, at which a predominant part, in particular more than 95% or more than 99%, of a potential difference between the high-voltage (HV) electrode and the output electrode may drop off Further, the previous flow-assisted CE systems were generated with gas pressure, which ensures a constant pressure across the CE capillary, but which does not ensure a constant flow of electrolyte solution and/or sample through the capillary. A non-constant flow of electrolyte solution and/or sample, in particular due to gas bubbles and/or interruption or discontinuation of the electroosmotic flow, may cause—in particular temporal—positions and/or distances between maxima and/or peaks in concentrations of individual sample constituents and/or components at the output of the capillary electrophoresis, in particular the separation capillary, to vary and or deviate from a value to be expected for the case of a constant flow. This, in turn, may make identification of sample constituents and/or components difficult or even lead to misidentification. In unfavorable cases, capillary electrophoresis and/or mass spectrometry may also come to a complete standstill, so that a complete analysis of the sample is impossible or prevented. A formation of gas bubbles may occur in particular at and/or in the area of the high-voltage electrode, and in particular may be due to an electrolysis of an aqueous component of the buffer and/or the electrolyte solution, but also due to a deposition in the buffer and/or the electrolyte solution of physically dissolved gases (e.g. nitrogen or oxygen from the atmosphere) on a comparatively rough surface of the high-voltage (HV) electrode.

The invention is therefore based on the task of providing a system for feeding a very small amount of sample in the nanoliter range, in particular sample amounts in the range of a few nanoliters or even fractions of nanoliters, in a substantially simplified and more robust process to a flow-controlled capillary electrophoresis system, which may be or is coupled to a mass spectrometer for analysis and/or detection of the sample, in particular for qualitative and/or quantitative determination or identification of sample constituents and/or components.

According to the invention, this may be achieved by using a nano pump, in particular a mechanical nano pump in the form of, in particular, a piston pump, an additional, in particular controlled, flow is fed to or superimposed on the electroosmotic flow, a magnitude ow which in particular exceeds the one of said electroosmotic flow; the sample is injected into the capillary electrophoresis capillary via a closable injection channel; the high-voltage electrode is located in the direction of flow, in particular in the direction of the controlled flow, and/or in the MS direction upstream of the closable injection channel; in that the increased gas content in the electrolyte solution, which is produced at the HV electrode by the electrolysis, is reduced by means of the pressure difference via a degassing membrane in such a way that no gas bubbles are produced in the capillary electrophoresis capillary, in particular enter the separating capillary or remain in the latter; in that the spray voltage in the mass spectrometer source is protected from the capillary electrophoresis high voltage via a voltage divider, and the electrolyte nano pump with the high voltage electrode compartment, the degassing region, the injection channel and the capillary electrophoresis capillary constitutes a closed system filled with electrolyte solution, wherein during operation the pump flow rate has to be higher than the electroosmotic flow generated by the CE high voltage.

A capillary electrophoresis apparatus according to the invention as claimed below includes the features of claim 1 as set forth below.

1. A capillary electrophoresis apparatus according to the invention may comprise:
a. a supply capillary;
b. a degassing conduit;
c. a separation capillary; where
d. the supply capillary, the degassing conduit, and separation capillary each have an inlet and an outlet connected to the inlet via a channel, wherein in particular the respective channel is adapted to conduct a liquid from the corresponding inlet to the connected outlet;
e. wherein the supply capillary, the degassing conduit, and the separation capillary are interconnected to form a continuous channel by means of which in particular liquid may be conducted from the inlet of the supply capillary to the outlet of the separation capillary;
f. an injection port for feeding sample substance, in particular a sample, into the separation capillary;
g. a pump by means of which electrolyte solution may be conveyed from a reservoir and pumped in the direction of and/or through the continuous channel;
h. a first electrode which extends inside the degassing conduit, in particular inside the channel of the degassing conduit.

The supply capillary and/or the separation capillary may each be designed as so-called fused silica capillaries, in particular with an inner diameter of at least approximately 20 μm.

The supply capillary may have a first channel which connects a first inlet, in particular formed at a first end of the supply capillary, to a first outlet, in particular formed at a second end of the supply capillary remote from the first end of the supply capillary, in particular in a liquid-tight and/or pressure-tight manner, wherein the first channel may be closed in a liquid-tight and/or pressure-tight manner apart from the first inlet and the first outlet. The supply capillary may have a first inner diameter, which may in particular be between 10 μm and 30 μm, in particular at least approximately 20 μm or at least approximately 25 μm.

The degassing conduit may have a second channel which connects a second inlet, in particular formed at a first end of the degassing conduit, to a second outlet, in particular formed at a second end of the degassing conduit remote from the first end of the degassing conduit, in a liquid-tight and/or pressure-tight manner, wherein the second channel may be closed in a liquid-tight and/or pressure-tight manner apart from the second inlet and the second outlet.

The separation capillary may have a third channel which connects a third inlet, in particular formed at a first end of the separation capillary, to a third outlet, in particular formed at a second end of the separation capillary remote from the first end of the separation capillary, in particular in a liquid-tight and/or pressure-tight manner, wherein the third channel may be closed in a liquid-tight and/or pressure-tight manner apart from the third inlet and the third outlet. The separation capillary may have a third inner diameter, which may be in particular between 20 μm and 80 μm, in particular at least approximately 25 μm or at least approximately 50 μm.

The supply capillary, the degassing conduit, and the separation capillary may be connected to each other directly and/or by means of connecting elements, in particular connected in a liquid-tight and/or pressure-tight manner, in order to form a continuous channel by means of which liquid, in particular electrolyte solution and/or sample substance, may be conducted from the first inlet formed in the supply capillary to the third outlet of the separation capillary. The connecting elements may be designed to be electrically insulating, in particular made of plastic.

The first, second, and/or third channels may be at least substantially cylindrical.

Electrolyte solution may be supplied to the capillary electrophoresis apparatus via the supply capillary and pumped through it, in particular through the continuous channel. For this purpose, a pump may be connected to the first inlet of the supply capillary, which delivers electrolyte solution from a reservoir.

The first outlet of the supply capillary may be connected to the second inlet of the degassing capillary, in particular in a liquid-tight and/or pressure-tight manner, via a first connecting element made of electrically insulating material. The first connecting element may be formed from and/or in an insulating body, in particular of plastic, in which a first sectionally at least approximately cylindrical or conical channel or a sectionally at least approximately cylindrical or conical bore may be formed, which has an opening at each of two opposite ends, so that one end of the supply capillary and a first end of the degassing conduit may be pressed into one opening in each case in such a way that a liquid-tight and/or pressure-tight connection is produced.

The degassing conduit may comprise a hose-shaped and/or tubular element which may be formed of a membrane made of amorphous fluoroplastic such as Teflon™ AF or of polytetrafluoroethylene (PTFE), and which may form or define at least part of the channel of the degassing conduit. In particular, the degassing conduit may be formed of a hose made of amorphous fluoroplastic such as Teflon™ AF or of polytetrafluoroethylene (PTFE), which may in particular be made in a commercially available manner, with a wall of the hose acting as a membrane. Tube and/or tubular element or hose may have a length of about 3.0 cm to 20 cm, in particular between 5.0 cm and 10 cm, and/or a second inner diameter in the range of a few tenths of a millimeter, in particular at least approximately 0.5 mm. The material for diaphragm and/or hose may be selected in particular in such a way that it is relatively weakly thermally compressed and/or relatively porous, whereby suitable and or optimum values or materials, which provide sufficient gas permeability, may be determined experimentally if necessary in dependence on the operating pressure of the pump.

The pump may be designed to deliver and/or pump a constant flow of electrolyte solution through the first inlet and/or the connected channel, in particular at a flow rate between 25 μl/min and 75 μl/min, preferably at least approximately 40 μL/min or at least approximately 50 μl/min. For this purpose, the pump may in particular have a closed-loop control, in particular a PID control. The pump may in particular be a nano pump, in particular a mechanical nano pump in the form in particular of a piston pump. The pump may be designed to provide electrolyte solution at a pressure of at least approximately one or a few bars (10⁵ N/m²); however, it may also be designed for higher pressures, for example up to at least approximately 50 bar.

Within the second channel of the degassing conduit, a first electrode may be provided, which may serve as a high-voltage (HV) electrode for capillary electrophoresis performed with the capillary electrophoresis apparatus. The first electrode may in particular be formed by a thin wire, in particular platinum wire, which extends at least approximately parallel to a longitudinal axis of the second channel, may have a length in the range of a few centimeters, in particular between 3.0 cm and 10 cm, and/or a diameter in the range of a few tenths of a millimeter, in particular at least approximately 0.2 mm. Such shaping of the electrode has the effect that, even if relatively large gas bubbles are formed which fill an entire internal cross-section of the degassing conduit or of the second channel, the first electrode always remains in contact or in contact with electrolyte solution in the region of the second outlet and/or of the separating capillary. Thus, at least a predominant portion of a high voltage applied to the first electrode always falls across the electrolyte solution located in the separation capillary, and interruption of electroosmotic flow is avoided or prevented. This advantage is enhanced by the fact that the first electrode extends inside or in the second of the degassing conduit and thus in the immediate vicinity of the membrane—thus gas bubbles that are formed may escape at least approximately immediately, thus avoiding or preventing a major accumulation or build-up of gas.

The first electrode may be connected to a terminal which is formed in the first connection element, in particular cast together with it, and to which a voltage source may be connected in order to supply the first electrode with high voltage. The terminal may be designed in particular as a platinum electrode.

The second outlet of the degassing conduit may be connected to the third inlet of the separation capillary, in particular in a liquid-tight and/or pressure-tight manner, via a second connecting element made of electrically insulating material. The second connecting element may be formed of and/or in an insulating body, in particular of plastic, in which a first sectionally at least approximately cylindrical or conical channel or a sectionally at least approximately cylindrical or conical bore may be formed, each having an opening at two opposite ends, so that a second end of the degassing conduit and an end of the separation capillary may be pressed into a respective opening in such a way that a liquid-tight and/or pressure-tight connection is formed. The second connection element may further comprise an injection port comprising a second sectionally at least approximately cylindrical or conical channel or a sectionally at least approximately cylindrical or conical bore opening into the first channel and accessible from an outside of the second connection element.

A length of the supply capillary and/or the separation capillary may be between 0.5 m and 1.5 m, preferably at least approximately 1.0 m. The length of the supply capillary selected in this way may ensure that the high voltage applied to the first electrode is kept safely away from the pump and a housing thereof, and/or that no excessive field strengths occur in the electrolyte solution in the supply capillary.

The first inner diameter d₁ or a first inner cross section of the supply capillary may in particular be chosen smaller than the third inner diameter d₂ or a third inner cross section of the separation capillary, in particular with 1.5d₁≤d₂, preferably with 2d₁≤d₂.

A choice of length and/or third inner diameter d₂ or third inner cross-section of the separation capillary reduces current flow through the electrolyte solution between the first electrode and the pump or pump housing that is grounded or at neutral potential when high voltage is applied. This reduces electrical losses and thus permits in particular a weaker design or dimensioning of the high-voltage source.

Unless otherwise indicated, an electrically conductive connection, in particular between any two units, including in particular nodes, points, terminals, elements, devices, etc., or combinations thereof, as used in this patent application, may mean a connection such as is made in particular by a wire, cable, busbar, track, trace or line on, for example, a (printed) circuit board, solder, etc. The electrically conductive connection is preferably at least substantially direct, in particular free of discrete elements, such as in particular resistors, capacitors, inductors or other passive or active elements or devices connected between the connected units. Thus, the electrically conductive connection has at least substantially negligible resistance, capacitance or inductance, preferably at least substantially no resistance, capacitance or inductance. In particular, the resistance, capacitance and/or inductance of the electrically conductive connection are exclusively parasitic in nature. Further, resistance, capacitance, and inductance of the electrically conductive connection are signifimaytly smaller (preferably by a factor of 1/100, 1/1000, or 1/10000) than resistances, capacitances, and inductances, respectively, of resistors, capacitors, and inductors connected by the electrically conductive connection and/or comprised by an electrical circuit or network comprising the electrically conductive connection.

Unless otherwise specified, an electrical connection is identical to an electrically conductive connection as defined above.

Unless otherwise specified, there is a connection, an electrically conductive connection as defined above, between two electrically connected or electrically conductively connected entities, especially nodes, points, terminals, elements, devices, etc., or combinations thereof.

Unless otherwise specified, a liquid-tight and/or pressure-tight connection between two liquid-conducting, -conducting and/or -storing elements may denote a connection through which a liquid may flow and/or be conducted from one element to the other without loss, in particular without escaping through or in the region of the connection, in particular under the static and/or dynamic liquid pressures usually prevailing, in particular in an operating state of an apparatus comprising the elements, which may in particular correspond at least approximately to a maximum working pressure of the pump. In an analogous manner, a liquid-tight and/or pressure-tight closure may close an element, in particular an opening of an element, without liquid being able to escape through or in the region of the closure.

### WAYS TO CARRY OUT THE INVENTION

In the following, a preferred embodiment of the invention is described with reference to the accompanying drawing.

It show

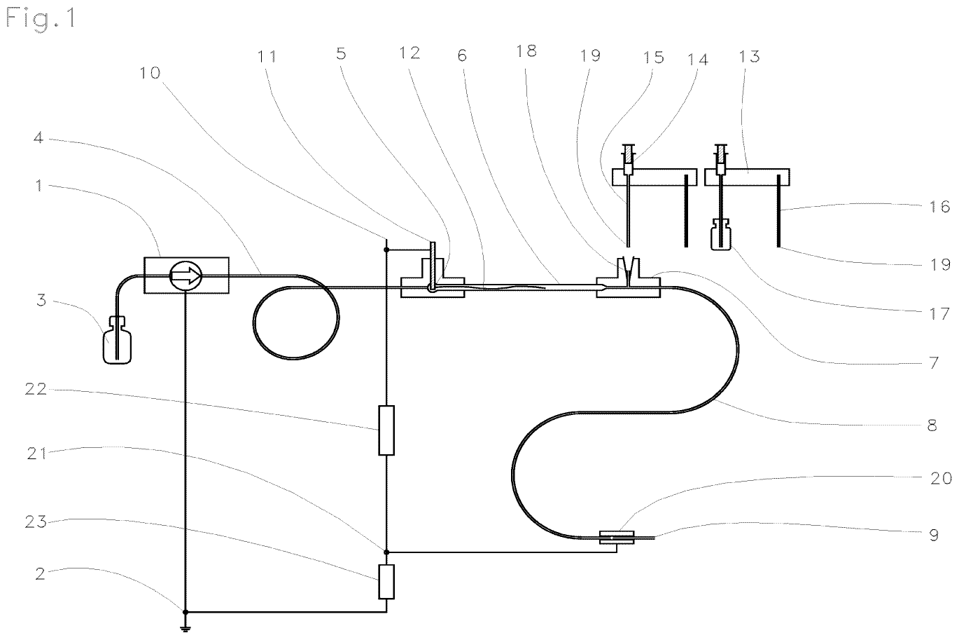

FIG. 1 A system setup of a capillary electrophoresis system comprising a capillary electrophoresis apparatus according to the invention

FIG. 1 shows a CE system with a pump in the form of a nano flow pump 1, which is at electrical ground potential or grounding 2 and feeds the CE system with electrolyte solution 3. Via a supply capillary in the form of an at least approximately 1 m long fused silica capillary 4 with an inner diameter of at least approximately 20 μm, electrolyte solution 3 is conveyed through a CE HV electrode compartment 5, through the degassing membrane 6 of a degassing conduit, through the injection module 7, through the CE capillary 8, which serves as a separation capillary, to a MS spray tip 9. The CE high voltage 10, which in particular may have a value U_{1,HV} with/U_{1,HV}/>15 kV, preferably/U_{1,HV}/30 kV, in particular/U_{1,HV}/≈30 kV, is connected to a platinum electrode 11 which is connected to a thin platinum wire 12, which in particular serves as the first electrode for the capillary electrophoresis and leads into the area of a degassing membrane 6. A robotic arm 13 is coupled to a syringe 14, which is connected to a loading capillary 15, and to a sealing capillary 16, so that the robotic arm 13 may pick up sample from a sample vessel 17 with the syringe 14 via the loading capillary 15 and then inject it into the CE capillary 8 through an injection port in the form of a sample channel 18 in the injection module 7. After injection, the sample channel 18 is closed by the corresponding robot arm position with the closure capillary 16. Both the loading capillary 15 and the closing capillary 16 are created on a front side 19 in such a way that they seal or respectively close the sample channel 18 against the outside when it is put on. The actual capillary electrophoresis begins when the CE high voltage 10 is applied. A delivery rate of the nano flow pump 1 must then be higher than an electroosmotic flow generated by the CE high voltage 10. This results in an overpressure, in particular of several bars, in the area of the degassing membrane 6, which is necessary so that gas components in the electrolyte solution and gas bubbles formed therein may diffuse through the degassing membrane 6. Due to the overpressure, no negative pressure, in particular no vacuum, needs to be applied to an outer side of the degassing membrane. An MS spray tip 9 for electrospray ionization, which may serve in particular as a second electrode for capillary electrophoresis, is brought via a contact adapter 20 and a contact point 21 to a spray potential necessary for electrospray ionization, in particular U_{2,HV} with 1 kV</U_{2,HV}|<3 kV, preferably/U_{2,HV}|≈1.3 kV, where the potential from contact point 21 is set by the MS. A high impedance voltage divider consisting of resistors 22, 23 ensures that the spray potential set by the MS across contact point 21 is not raised to the CE high voltage 10.

Although the invention is illustrated and described in detail by means of the figures and the accompanying description, this illustration and this detailed description are to be understood as illustrative and exemplary and not as limiting the invention. In order not to glorify the invention, in certain cases well known structures and techniques may not be shown and described in detail. It is understood that those skilled in the art may make changes and variations without departing from the scope of the following claims. In particular, the present invention covers further embodiments with any combinations of features that may differ from the explicitly described combinations of features.

The present disclosure also encompasses embodiments having any combination of features mentioned or shown above or below with respect to various embodiments or embodiments. It also encompasses individual features in the figures, even if they are shown there in connection with other features and/or are not mentioned above or below. Also, the alternatives of embodiments described in the figures and the description and individual alternatives of their features may be excluded from the subject matter of the invention or the disclosed subject matter. The disclosure includes embodiments that exclusively comprise the features described in the claims or in the embodiments, respectively, as well as those that comprise additional other features.

Furthermore, the term “include” and derivatives thereof does not exclude other elements or steps. Likewise, the indefinite article “a” or “one” and derivatives thereof do not exclude a plurality. The functions of a plurality of features recited in the claims may be performed by one unit or step, respectively. The terms “substantially”, “approximately”, “approximately”, “approximately”, “approximately” as well as their synonyms in connection with a property or a value, respectively, may in particular also designate exactly the property or exactly the value, respectively. The terms “about”, “approximately”, “approximately”, “approximately”, as well as their synonyms, in connection with a given numerical value or range may refer to a value or range, respectively, that lies within 20%, within 10%, within 5% or within 2% of the given value or range, respectively. All reference signs in the claims are not to be understood as limiting the scope of the claims. A claim, according to which a b holds or a is approximately, about, approximately equal to or approximately equal to b, may be understood to mean that /a−b//(/a/+/b/)<0.2, preferably /a−b//(/a/+/b/)<0.05, most preferably /a−b//(/a/+/b/)<0.01, where a and b may represent any variables or quantities defined and/or described anywhere in this document or otherwise known to the skilled person. An indication “a few” may in particular mean at least two, preferably at least three and/or at most five. An indication “some” may mean in particular at least three, preferably at least five and/or at most nine.

The fact that a feature or property, for example a specific, in particular geometric, shape, is at least approximately or essentially formed, provided or present may also mean in particular that manufacturing specifications exist which provide for a specification according to which the feature is to be formed accordingly, whereby a deviation from the specification may result in particular within the scope of usual manufacturing tolerances.

That an element or feature is extended in a direction, runs in a direction, or extends in a direction may mean in particular that dimensions of the element or feature in or with respect to this direction are greater than in or with respect to other, in particular all other directions, in particular orthogonal directions.

In particular, the invention according to the above description may be realized in the form of and/or in combination with the following embodiments:
1. Capillary electrophoresis, characterized in that an additional flow is superimposed on the electroosmotic flow by means of a nano liquid pump and a degassing membrane is located between the CE high-voltage electrode and the CE capillary, through which gas components may escape from the electrolyte solution.
2. Method according to variant 1, characterized in that the nano liquid pump is grounded and connected to the CE high voltage by means of a long thin non-conducting capillary through the electrolyte solution only.
3. Method according to variant 1, characterized in that the injection module is at a lower electrical potential than the CE high-voltage electrode.
4. Method according to variant 1, characterized in that in the injection module the sample channel leads directly via a T-connection into the CE capillary and the sample channel is closed after sample introduction before the CE high voltage is switched on.
5. Capillary electrophoresis apparatus, comprising:
   a. a supply capillary (4);
   b. a degassing conduit (6);
   c. a separation capillary (8); wherein
   d. the supply capillary (4), the degassing conduit (6), and separation capillary (8) each have an inlet and an outlet connected to the inlet via a channel, wherein in particular the respective channel is adapted to conduct a liquid from the corresponding inlet to the connected outlet;
   e. wherein the supply capillary (4), the degassing conduit (6), and the separation capillary (8) are connected to each other to form a continuous channel by means of which liquid may, in particular, be conducted from the inlet of the supply capillary (4) to the outlet of the separation capillary (8);
   f. an injection port (18) for feeding sample substance into the separation capillary (8);
   g. a pump (1), by means of which electrolyte solution may be conveyed from a reservoir (3) and pumped in the direction of and/or through the continuous channel;
   h. a first electrode (12) extending inside the degassing conduit (6), in particular inside the channel of the degassing conduit (6).
6. Capillary electrophoresis apparatus according to any of the preceding embodiments, characterized in that the first electrode comprises a wire, preferably a platinum wire (12), which extends within the channel of the degassing conduit (6), preferably at least approximately parallel to a longitudinal axis and/or longitudinal direction of the channel.
7. Capillary electrophoresis apparatus according to one of the preceding embodiments, characterized in that a length l₁ of the supply capillary (4) corresponds at least approximately to a length l₁ of the separation capillary (8), in particular with 0.5 l₁≤l₂≤2 l₁, preferably with 0.8 l₁≤l₂≤1.25 l₁.
8. Capillary electrophoresis apparatus according to one of the preceding embodiments, characterized by an injection module (7) which connects the outlet of the degassing conduit (6) to the inlet of the separation capillary (8) in such a way that liquid, in particular electrolyte solution, is conducted from the degassing conduit (6) to the separation capillary (8), wherein the injection module has a closable opening as injection port (18), which is preferably formed in a region between degassing conduit (6), in particular the outlet of the degassing conduit (6), and separation capillary (8), in particular the inlet of the separation capillary (8).
9. Capillary electrophoresis apparatus according to one of the preceding embodiments, characterized in that the degassing conduit (6) comprises a gas-permeable membrane, in particular formed at least partially from amorphous fluoroplastic such as Teflon™ AF or from polytetrafluoroethylene (PTFE).
10. Capillary electrophoresis apparatus according to embodiment 10, characterized in that the electrolyte solution in the degassing conduit (6) is flowed and/or conducted over an inner side of the gas-permeable membrane.
11. Capillary electrophoresis apparatus according to embodiment 10 or 11, characterized in that degassing conduit (6) comprises a hose-shaped and/or tubular element which is formed of a membrane of amorphous fluoroplastic such as Teflon™ AF or of polytetrafluoroethylene (PTFE) and which forms at least part of the channel of the degassing conduit (6).
12. A capillary electrophoresis apparatus according to any of the preceding embodiments, further comprising a second electrode arranged at the outlet or in a region of the outlet of the separation capillary (8).
13. Capillary electrophoresis apparatus according to embodiment 12, characterized in that the second electrode is formed on or as part of a connecting element (20) by means of which an eluate emerging from the outlet of the separation capillary may be supplied to a mass spectrometry apparatus.
14. Capillary electrophoresis apparatus according to any one of the preceding embodiments, further comprising.
   i. a first terminal (11), which is electrically conductively connected to the first electrode (12);
   j. a second terminal which is electrically conductively connected to the second electrode (12);
   k. a voltage divider which is electrically conductively connected to the first terminal and, when a voltage U₁ is applied to the first terminal, provides a second voltage U₂ at a tap terminal (21), where U₂=U₁/T with T>1, preferably T>5, T>10, and/or T>>1; and where
   l. the tap terminal is electrically conductively connected to the second electrode (12).
15. A capillary electrophoresis apparatus according to any of the preceding embodiments, further comprising a third electrode disposed at the inlet or in a region of the inlet of the supply capillary (4).
16. Capillary electrophoresis system comprising
   m. a capillary electrophoresis apparatus according to embodiments 8 to 11;
   n. a voltage source (10) for providing a high voltage U_{1,Hv} at the first electrode, in particular with /U_{1,HV}/>15 kV, preferably /U_{1,HV}/≥30 kV.
17. The capillary electrophoresis system of claim 12, characterized in that the voltage source is further adapted to,
   o. provide a second voltage U_{2,HV} at the second electrode, where U_{2,HV}=U_{1;HV}/T with T>1, preferably T>5, T>10, and/or T>>1; and/or
   p. to provide a ground potential, a neutral voltage and/or a grounding at the pump (1), in particular a housing of the pump and/or a terminal for the supply capillary at the pump, and/or at the third electrode.
18. Capillary electrophoresis system comprising
   q. A capillary electrophoresis apparatus according to any one of embodiments 5 to 15;
   r. an sample feeder (13) designed to
      i. feed a sample, in particular from a sample vessel (17), to the capillary electrophoresis apparatus via the injection port (18),
      ii. and which preferably has a means (16) for closing the injection port (18).

1. A capillary electrophoresis apparatus, comprising:
a. a supply capillary;
b. a degassing conduit;
c. a separation capillary; wherein
d. the supply capillary, the degassing conduit, and separation capillary each have an inlet and an outlet connected to the inlet via a channel, wherein in particular the respective channel is adapted to conduct a liquid from the corresponding inlet to the connected outlet;
e. wherein the supply capillary, the degassing conduit, and the separation capillary are connected to each other to form a continuous channel by means of which in particular liquid may be conducted from the inlet of the supply capillary to the outlet of the separation capillary;
f. an injection port for feeding sample substance into the separation capillary;
g. a pump, by means of which electrolyte solution may be conveyed from a reservoir and pumped in the direction of or through the continuous channel; and
h. a first electrode extending inside the degassing conduit.

2. The capillary electrophoresis apparatus according to claim 1, wherein the first electrode comprises a wire extending within the channel of the degassing conduit, wherein the degassing conduit is parallel to a longitudinal axis or longitudinal direction of the channel.

3. The capillary electrophoresis apparatus according to claim 1, wherein a length l₁ of the supply capillary corresponds to a length l₂ of the separation capillary.

4. The capillary electrophoresis apparatus according to claim 1, wherein an inner diameter d₁ of the supply capillary is selected to be smaller than an inner diameter d₂ of the separation capillary.

5. The capillary electrophoresis apparatus according to claim 1, further comprising an injection module which connects the outlet of the degassing conduit to the inlet of the separation capillary wherein a liquid, is conducted from the degassing conduit to the separation capillary, wherein the injection module has a closable opening as injection port formed in a region between degassing conduit, and separation capillary.

6. The capillary electrophoresis apparatus according to claim 1, wherein the degassing conduit comprises a gas-permeable membrane.

7. The capillary electrophoresis apparatus according to claim 5, wherein the liquid is an electrolyte solution such that the electrolyte solution in the degassing conduit is flowed or conducted over an inner side of the gas-permeable membrane.

8. The capillary electrophoresis apparatus according to claim 6, wherein the degassing conduit comprises a hose-shaped or tubular element formed of a membrane of amorphous fluoroplastic or of polytetrafluoroethylene (PTFE) and which forms at least part of the channel of the degassing conduit.

9. The capillary electrophoresis apparatus according to claim 1, further comprising a second electrode which is arranged at the outlet or in a region of the outlet of the separation capillary further comprising a needle or tip for a spray ionization.

10. The capillary electrophoresis apparatus according to claim 9, wherein the second electrode is formed on or as part of a connecting element by means of which an eluate emerging from the outlet of the separation capillary is supplied to a mass spectrometry apparatus.

11. The capillary electrophoresis apparatus according to claim 1, further comprising.
a. a first terminal, which is electrically conductively connected to the first electrode;
b. a second terminal which is electrically conductively connected to the second electrode;
c. a voltage divider which is electrically conductively connected to the first terminal and, when a voltage U₁ is applied to the first terminal, provides a second voltage U₂ at a tap terminal, where U₂=U₁/T with T>1, preferably T>5, T>10, or T>>1 or 1 kV<|U_{2,HV}|<3 kV, preferably |U_{2,HV}|≈1.3 kV; and where
d. the tap terminal is electrically conductively connected to the second electrode.

12. The capillary electrophoresis apparatus according to claim 1, further comprising.
a. a first terminal, which is electrically conductively connected to the first electrode; and
b. a voltage divider which is electrically conductively connected to the first terminal and, when a voltage U₁ is applied to the first terminal, provides a second voltage U₂ at a tap terminal, where U₂=U₁/T with T>1, preferably T>5, T>10, or T>>1 or 1 kV<|U|_{2,HV}<3 kV, preferably |U|_{2,HV}≈1.3 kV; and wherein
c. the tap terminal is electrically conductively connected to the mass spectrometry apparatus, in particular to an inlet opening of the mass spectrometry apparatus;
d. the second electrode is preferably grounded or connected to a neutral potential.

13. The capillary electrophoresis apparatus according to claim 12, further comprising a third electrode arranged at the inlet or in a region of the inlet of the supply capillary, and grounded or connected to a neutral potential.

14. A Capillary electrophoresis system, comprising
a. a capillary electrophoresis apparatus comprising a hose-shaped or tubular element formed of a membrane of amorphous fluoroplastic or of polytetrafluoroethylene (PTFE) and which forms at least part of the channel of the degassing conduit;
b. a second electrode which is arranged at the outlet or in a region of the outlet of the separation capillary further comprising a needle or tip for a spray ionization;
c. a first terminal, which is electrically conductively connected to the first electrode;
d. a second terminal which is electrically conductively connected to the second electrode;
e. a voltage divider which is electrically conductively connected to the first terminal and, when a voltage U₁ is applied to the first terminal, provides a second voltage U₂ at a tap terminal, where U₂=U₁/T with T>1, preferably T>5, T>10, or T>>1 or 1 kV<|U_{2,HV}|<3 kV, preferably |U_{2,HV}|≈1.3 kV; and where
f. the tap connection is electrically conductively connected to the second electrode; and
g. a voltage source for providing a high voltage U_{1,HV} at the first electrode.

15. The capillary electrophoresis system of claim 14, wherein the voltage source is further adapted to,
a. provide a second voltage U_{2,HV} at the second electrode, where U_{2,HV}=U_{1;HV}/T with T>1; or
b. to provide a ground potential, a neutral voltage or a grounding at the pump.

16. (canceled)

17. The capillary electrophoresis apparatus according to claim 3, wherein the length l₁ of the supply capillary corresponds at least approximately to the length l₂ of the separation capillary wherein the length of the supply is 0.8 l₁≤l₂≤1.25 l₁.

18. The capillary electrophoresis apparatus according to claim 1, wherein the injection module has a closable opening as injection port formed in a region between the outlet of the degassing and the inlet of the separation capillary.

19. The capillary electrophoresis system according to claim 14, wherein the voltage source is further adapted to provide a ground potential, a neutral voltage and a grounding at a housing of the pump, a terminal for the supply capillary at the pump, and at the third electrode.

20. A Capillary electrophoresis system, comprising
a. a capillary electrophoresis apparatus comprising a hose-shaped or tubular element formed of a membrane of amorphous fluoroplastic or of polytetrafluoroethylene (PTFE) and which forms at least part of the channel of the degassing conduit;
b. a second electrode which is arranged at the outlet or in a region of the outlet of the separation capillary further comprising a needle or tip for a spray ionization;
c. a first terminal, which is electrically conductively connected to the first electrode;
d. a second terminal which is electrically conductively connected to the second electrode;
e. a voltage divider which is electrically conductively connected to the first terminal and, when a voltage U₁ is applied to the first terminal, provides a second voltage U₂ at a tap terminal, where U₂=U₁/T with T>1, preferably T>5, T>10, or T>>1 or 1 kV<|U|_{2,HV}<3 kV, preferably |U|_{2,HV}≈1.3 kV; and wherein the tap connection is electrically conductively connected to the mass spectrometry apparatus, in particular to an inlet opening of the mass spectrometry apparatus;
f. the second electrode is preferably grounded or connected to a neutral potential; and
g. a voltage source for providing a high voltage U_{1,HV} at the first electrode.
